(19) United States
(12) Patent Application Publication
(10) Pub. No.: US 2026/0061887 A1
(43) Pub. Date: Mar. 5, 2026

(54) CHARGING CONTROL METHOD FOR BATTERY SYSTEM AND VEHICLE USING THE SAME

(71) Applicants: Hyundai Motor Company, Seoul (KR); Kia Corporation, Seoul (KR)

(72) Inventors: Yunjoong PARK, Hwaseong-Si (KR); Jeongtaek OH, Hwaseong-Si (KR); Kwangseob OH, Hwaseong-Si (KR); Hyungrae CHO, Hwaseong-Si (KR)

(21) Appl. No.: 19/288,281

(22) Filed: Aug. 1, 2025

(30) Foreign Application Priority Data
Sep. 3, 2024 (KR) 10-2024-0118916

(51) Int. Cl. B60L 58/13; B60L 7/14; B60L 53/57

(52) U.S. Cl. CPC B60L 58/13; B60L 7/14; B60L 53/57; B60L 2210/40; B60L 2240/463; B60L 2240/622

(57) ABSTRACT

A vehicle may comprise a motor configured to provide power to the vehicle, an inverter electrically connected to the motor and configured to supply power to the motor or receive power from the motor, a battery system configured to supply power to the inverter or receive charging power from the inverter, a Global Positioning System (GPS) device configured to measure an altitude of the vehicle, and in-vehicle infotainment (IVI) circuitry configured to compare the measured altitude of the vehicle with a predetermined first threshold altitude and limit, based on the measured altitude being higher than or equal to the predetermined first threshold altitude, a target state of charge (SOC) for the battery system to a predetermined first SOC value.

### CROSS-REFERENCE TO RELATED APPLICATION

This application claims the benefit of priority to Korean Patent Application No. 10-2024-0118916 filed in the Korean Intellectual Property Office on Sep. 3, 2024, the entire contents of which are incorporated herein by reference.

### TECHNICAL FIELD

The present disclosure relates to a charging control method for a battery system and a vehicle using the same.

### BACKGROUND

The matters described in this Background section are only for enhancement of understanding of the background of the disclosure, and should not be taken as acknowledgment that they correspond to prior art already known to those skilled in the art.

When a vehicle descends from a high-altitude ground to a low-altitude ground, friction braking may occur continuously using a driving brake. The friction braking causes heat in a brake disc. In a case where the movement distance from the high-altitude ground to the low-altitude ground is significant, the heat is generated in the brake disc for a long period of time, which may cause a deformation of the brake disc. It is necessary to prevent continuous friction braking during the driving of the vehicle on a long downhill road. Hereinafter, the long-downhill driving will be referred to as long-downhill driving.

To reduce friction braking, it is necessary to utilize regenerative braking, but regenerative braking may be limited depending on the state of charge of the battery.

### SUMMARY

The present disclosure attempts to provide a charging control method for a battery system capable of increasing regenerative braking during long-downhill driving, and a vehicle using the same.

According to the present disclosure, a vehicle may comprise a motor configured to provide power to the vehicle, an inverter electrically connected to the motor, and configured to supply power to the motor or receive power from the motor, a battery system configured to supply power to the inverter or receive charging power from the inverter, a Global Positioning System (GPS) device configured to measure an altitude of the vehicle, and in-vehicle infotainment (IVI) circuitry configured to, compare the measured altitude of the vehicle with a predetermined first threshold altitude, and limit, based on the measured altitude of the vehicle being higher than or equal to the predetermined first threshold altitude, a target state of charge (SOC) for the battery system to a predetermined first SOC value.

The vehicle may further comprise an ignition interface configured to cause driving or stopping the motor, wherein, based on receiving a signal from the ignition interface to instruct the vehicle to be turned on, the IVI circuitry is configured to compare the altitude of the vehicle with the predetermined first threshold altitude. The vehicle, wherein the IVI circuitry is configured to transmit the limited target SOC to the battery system, and the battery system is configured to perform charging based on the limited target SOC.

The vehicle may further comprise a charging interface electrically connected to the battery system, wherein the battery system may comprise a battery pack including a plurality of cells, and a battery management circuit configured to control charging of the battery pack, and during the charging, the battery management circuit is configured to estimate an SOC of the battery pack, and cause the charging interface to stop the charging of the battery pack based on the SOC reaching the limited target SOC.

The vehicle, wherein the IVI circuitry is configured to, compare an altitude difference with a predetermined second threshold altitude, wherein the altitude difference is a difference between the measured altitude of the vehicle and an altitude of a destination of the vehicle, and limit the target SOC for the battery system to a predetermined second SOC value based on the altitude difference being higher than or equal to the predetermined second threshold altitude.

The vehicle, wherein the target SOC is limited such that at least a portion of regenerative power generated during downhill driving of the vehicle is provided to charge a battery of the battery system instead of using friction braking for reducing a speed of the vehicle. The vehicle may further comprise a regenerative braking control circuit configured to allocate, based on the limited target SOC, braking torque between friction braking of the vehicle and regenerative braking of the vehicle.

According to the present disclosure, a method performed by a vehicle, the method may comprise obtaining, via a Global Positioning System (GPS) device of the vehicle, position information of the vehicle, determining, based on the position information, an altitude of the vehicle, comparing, via in-vehicle infotainment (IVI) circuitry of the vehicle, the altitude of the vehicle with a predetermined first threshold altitude, and based on the altitude of the vehicle being higher than or equal to the predetermined first threshold altitude, limiting, via the IVI circuitry of the vehicle, a target SOC for a battery system of the vehicle to a predetermined first SOC value.

The method may further comprise transmitting, via the IVI circuitry of the vehicle, the limited target SOC to the battery system, and controlling, via a charging interface of the battery system and based on the limited target SOC, charging of the battery system. The method, wherein the obtaining of the position information may comprise obtaining, based on turning on the vehicle, the position information. The method, wherein the obtaining of the position information may comprise obtaining the position information at every predetermined measurement cycle while the vehicle is moving.

The method may further comprise comparing an altitude difference with a predetermined second threshold altitude, wherein the altitude difference is a difference between the determined altitude of the vehicle and an altitude of a destination of the vehicle, and based on the altitude difference being higher than or equal to the predetermined second threshold altitude, limiting the target SOC for the battery system to a predetermined second SOC value.

The method may further comprise displaying, by the IVI circuitry and via a display device of the vehicle, the limited target SOC. The method, wherein the limiting of the target SOC is performed such that at least a portion of regenerative power generated during downhill driving of the vehicle is provided to charge a battery of the battery system instead of using friction braking for reducing a speed of the vehicle. The method may further comprise allocating, based on the limited target SOC, braking torque between friction braking of the vehicle and regenerative braking of the vehicle.

According to the present disclosure, a vehicle may comprise a motor configured to provide driving power for the vehicle, an inverter configured to supply power to the motor or receive power from the motor, a battery system configured to supply power to the inverter or receive charging power from the inverter, a positioning circuit configured to determine an altitude of the vehicle, and onboard information circuitry configured to, determine, based on the altitude of the vehicle satisfying a predetermined threshold, an estimated power generation by regenerative braking of the vehicle via a downhill driving, based on the determined estimated power generation, set a limit to a target state of charge (SOC) of the battery system such that the target SOC does not exceed a predetermined SOC value lower than a full charge, and provide information indicating the limited target SOC to the battery system to reserve regenerative braking capacity of the battery system, wherein the battery system is further configured to limit charging of a battery pack based on the limited target SOC, such that at least a portion of regenerative power generated during downhill driving is provided to the battery pack of the battery system.

The vehicle, wherein the motor is configured to generate electric power by applying regenerative braking of the vehicle during downhill driving, and wherein the electric power generated by the motor is provided to charge the battery pack an SOC level that is above the limited target SOC. The vehicle may further comprise a regenerative braking control circuit configured to allocate, based on the limited target SOC, braking torque between friction braking of the vehicle and regenerative braking of the vehicle.

The vehicle, wherein the threshold may comprise a first threshold altitude for determining whether a current altitude of the vehicle is greater than or equal to the first threshold altitude, and a second threshold altitude for determining whether a difference between the current altitude of the vehicle and an altitude of a destination of the vehicle is greater than or equal to the second threshold altitude.

The vehicle, wherein the positioning circuit is further configured to determine, based on navigation data of the vehicle, an altitude of a destination of the vehicle, and wherein the onboard information circuitry is further configured to determine an altitude difference between the altitude of the vehicle and the altitude of the destination and compare the altitude difference with a threshold difference to determine the estimated power generation by regenerative braking.

### BRIEF DESCRIPTION OF THE DRAWINGS

FIG. 1 shows an example of a configuration of a vehicle according to an example.

FIG. 2, FIG. 3, FIG. 4, and FIG. 5 are exemplary flowcharts each showing a charging control method for a battery system according to an example.

FIG. 6 shows an example computing system (e.g., a computing device of a vehicle or any other apparatus).

### DETAILED DESCRIPTION

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of controlling battery charge based on altitude) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of controlling battery charge based on altitude) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of controlling battery charge based on altitude) described herein.

Minimum risk maneuver (MRM) operation(s) may also be controlled, for example, based on one or more features (e.g., features of controlling battery charge based on altitude) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of controlling battery charge based on altitude) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of controlling battery charge based on altitude) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features of controlling battery charge based on altitude) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

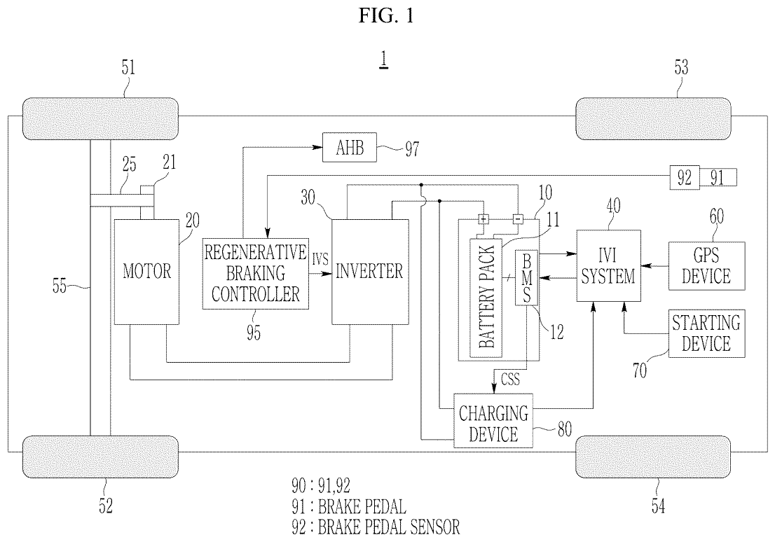

FIG. 1 shows an example of a configuration of a vehicle according to an example.

As illustrated in FIG. 1, a vehicle 1 may include a battery system 10, a motor 20, an inverter 30, an in-vehicle information (IVI) system 40, a plurality of wheels 51 to 54 (e.g., front-drive wheels, rear steering wheels, or all-terrain wheels, etc.), a GPS device 60, a starting device 70, a charging device 80, and a braking device 90.

In FIG. 1, two wheels 51 and 52 among the plurality of wheels 50 may be mechanically connected to both ends of a power shaft 55 (e.g., via constant velocity joints, universal joints, or differential gears, etc.), and the two wheels 51 and 52 may rotate as the power shaft 55 rotates. The two wheels 53 and 54 may control steering of the vehicle 1. The motor 20 is a component that provides power to the vehicle 1, and is electrically connected to the inverter 30.

The inverter 30 may be a bidirectional inverter, which converts DC power supplied from the battery system 10 into AC power (e.g., sinusoidal, trapezoidal, or square-wave AC, etc.) and supplies the AC power to the motor 20, and the motor 20 operates according to the supplied power, enabling a rotor 21 to rotate. The rotor 21 may be mechanically connected to the power shaft 55 through a coupler, such as a coupling means 25. The coupling means 25 may be implemented as a gear box (e.g., a single-speed reducer, a multi-speed transmission, a planetary gear set, or a dual-clutch system, etc.) providing a gear shift function. The motor 20 operates to rotate the rotor 21, the power shaft 55 rotates according to the rotation of the rotor 21, and the two wheels 51 and 52 rotate according to the rotation of the power shaft 55, enabling the vehicle 1 to travel (e.g., in forward, reverse, or regenerative braking modes, etc.). During regenerative braking, the rotor 21 of the motor 20 may rotate, and regenerative power (e.g., induced by vehicle deceleration, downhill driving, or braking input, etc.) may be generated in the motor 20 according to the regenerative braking and may be supplied to the inverter 30. The inverter 30 may convert the regenerative power (AC power) supplied from the motor 20 into DC power (e.g., using a rectifier bridge, PWM-based switching, or synchronous rectification, etc.) and supply the DC power as charging power to the battery system 10.

The motor, the power shaft, and the wheels illustrated in FIG. 1 are examples, and the disclosure is not limited thereto. Unlike what is illustrated in FIG. 1, an in-wheel motor type in which an electric motor is mounted in a housing of each wheel (e.g., front in-wheel drive, rear in-wheel drive, or four-wheel in-wheel drive, etc.) may be applied to the vehicle 1.

The battery system 10 may supply power necessary for operating and controlling the vehicle 1 (e.g., powering the traction motor, infotainment system, lighting system, or electronic control units, etc.). The battery system 10 may be electrically connected to the inverter 30 to supply DC power to the inverter 30, or may receive charging power according to regenerative power from the inverter 30 (e.g., during deceleration, downhill driving, or braking, etc.). For example, a DC output of the battery system 10 may be supplied to the inverter 30, and the inverter 30 may convert the DC output into an AC output (e.g., three-phase AC, single-phase AC, or variable-frequency AC, etc.) and supply the AC output to the motor 20. The inverter 30 may convert the regenerative power provided from the motor 20 into DC power (e.g., using pulse width modulation switching, a bridge circuit, or synchronous rectification, etc.) and supply it as charging power to the battery system 10. A BMS 12 may control the battery system 10 to charge a battery pack 11 (e.g., by regulating voltage, current, or temperature thresholds, etc.) with the charging power supplied from the inverter 30.

The battery system 10 may include a battery pack 11 and a battery management system (BMS) 12. The battery pack 11 may include a plurality of battery cells electrically connected to each other (e.g., lithium-ion cells, lithium iron phosphate cells, solid-state cells, or nickel-metal hydride cells, etc.). The BMS 12 (e.g., battery control circuit or circuitry, battery management circuit or circuitry, etc.) may measure a current, a temperature, and the like of the battery pack 11 (e.g., internal resistance, ambient temperature, or humidity, etc.), and may measure a plurality of cell voltages of the plurality of battery cells. The BMS 12 may estimate an SOC of the battery pack 11 based on a measurement result (e.g., using coulomb counting, open-circuit voltage, or a Kalman filter, etc.), and control the charging/discharging of the battery pack 11 based on the estimated SOC. The BMS 12 may control and perform cell balancing operations for the plurality of battery cells based on the measurement result (e.g., using passive balancing, active balancing, or bypass resistors, etc.), and estimate degradation degrees for the plurality of battery cells (e.g., based on cycle count, capacity fade, or internal resistance increase, etc.). The BMS 12 may detect an abnormal state of the battery system 10 based on the measurement result (e.g., overvoltage, overcurrent, thermal runaway, or internal short circuit, etc.). Two terminals (+, −) of the battery system 10 may be connected to two input terminals of the inverter 30, and may be connected to two output terminals of the charging device 80.

The BMS 12 may stop charging the battery pack 11 if the SOC of the battery pack 11 reaches a set target SOC (e.g., 70%, 80%, 90%, or 95%, etc.) during the charging of the battery pack 11. The BMS 12 may transmit a charging control signal (CSS) to the charging device 80 to instruct the charging device 80 to stop the charging (e.g., when the SOC reaches a preset threshold or a thermal limit is detected, etc.). When charging power is supplied from either the charging device 80 or the inverter 30, the BMS 12 may control the battery pack 11 to connect the two terminals (+, −) (e.g., by activating main relays, contactors, or pre-charge circuits, etc.). Although not illustrated in FIG. 1, the battery pack 11 may include relays that connect the plurality of battery cells and the two terminals (+, −) to each other, and the BMS 12 may close the relays for charging (e.g., via a pre-charge relay, main relay, or contactor, etc.).

The braking device 90 may include a brake pedal 91 and a brake pedal sensor 92 (e.g., a position sensor, force sensor, or pressure transducer, etc.). The brake pedal sensor 92 may detect a pressure and a depth of the brake pedal 91 to determine a required braking amount and provide the required braking amount to a regenerative braking controller 95 (e.g., a microcontroller, digital processor, or analog logic circuit, etc.).

The regenerative braking controller 95 may calculate a total braking amount according to the required braking amount, distribute the total braking amount to a hydraulic braking amount and a regenerative braking request amount, monitor an actually provided regenerative braking execution amount, and correct the hydraulic braking amount (e.g., to avoid excessive brake force, improve energy recovery, or maintain stability, etc.). The regenerative braking controller 95 may determine the regenerative braking request amount based on the required braking amount, the state of charge (SOC) of the battery system 10, and an available motor torque. The available motor torque refers to a torque that the motor 20 can provide at a current speed of the vehicle 1 (e.g., depending on inverter output limits, rotor speed, or thermal constraints, etc.). The regenerative braking controller 95 may determine a regenerative braking torque to be provided by the motor 20 according to the regenerative braking request amount (e.g., based on wheel speed, motor efficiency, or battery charge acceptance rate, etc.), and control the inverter 30 to provide the determined regenerative braking torque. The regenerative braking controller 95 may calculate a regenerative braking execution amount using the regenerative braking torque that is actually provided by the motor 20 (e.g., based on sensor feedback or real-time motor current, etc.). The regenerative braking controller 95 may correct the hydraulic braking amount according to a value obtained by subtracting the regenerative braking execution amount from the total braking amount (e.g., to ensure smooth deceleration, prevent wheel lockup, or improve energy efficiency, etc.). The regenerative braking controller 95 may transmit the corrected hydraulic braking amount to an active hydraulic booster (AHB) (e.g., an electro-hydraulic unit, brake-by-wire actuator, or vacuum-independent brake booster, etc.). The AHB 97 may generate a hydraulic pressure according to the hydraulic braking amount, and provide the hydraulic pressure to brake calipers of the plurality of wheels 51 to 54 (e.g., via brake fluid lines, master cylinder, or electronic brake actuators, etc.).

The regenerative braking controller 95 may generate an inverter control signal IVS and provide the inverter control signal IVS to the inverter 30 so that the motor 20 provides a regenerative braking torque. The inverter control signal IVS may include pulse width modulation (PWM) signals (e.g., sinusoidal PWM, space vector PWM, or trapezoidal PWM, etc.) for controlling a switching operation of the inverter 30.

The inverter 30 may operate according to the inverter control signal IVS to convert power generated according to the regenerative braking torque provided by the motor 20 into charging power.

The GPS device 60 (e.g., GPS chipsets, satellite positioning receiver, positioning signal receiver, satellite navigation circuit, onboard location receiver, etc.) may measure a current position of the vehicle 1, and generate position information indicating the current position of the vehicle 1 (e.g., using satellite triangulation, correction data, or real-time kinematic positioning, etc.). The GPS device 60 may provide the position information to the IVI system 40. The position information may include latitude, longitude, and altitude.

The starting device 70 (e.g., ignition interface, ignition switch assembly, vehicle activation interface, driver input switch, etc.) may receive an input of a driver's operation of turning on or off the vehicle 1 (e.g., via a push-button switch, a key fob signal, or a touchscreen interface, etc.), and may perform a control operation of driving or stopping the motor 20 according to the received input of the operation. When the vehicle 1 is turned on, the battery system 10, the inverter 30, and the motor 20 may be electrically connected to each other, and DC power supplied from the battery system 10 may be converted into AC power by the inverter 30 and the AC power may be supplied to the motor 20 (e.g., to initiate torque output for vehicle propulsion, etc.). When the vehicle 1 is turned off, the electrical connection between the battery system 10 and the inverter 30 may be cut off (e.g., via a relay, contactor, or electronic switch, etc.). The starting device 70 may provide a starting signal to the IVI system 40 to instruct the vehicle 1 to be turned on or off.

The charging device 80 (e.g., charging interface circuit, vehicle charging interface, charging power interface, charging inlet circuitry, etc.) may be electrically connected to the battery system 10 to supply charging power (e.g., during plug-in charging at home, public stations, or service facilities, etc.). The charging device 80 may provide at least one of fast charging and slow charging. When a charger is electrically connected to an inlet, the charging device 80 may distinguish whether the connected charger is a fast charger or a slow charger (e.g., based on communication protocols, voltage levels, or current capacity, etc.). In a case where the connected charger is a fast charger, the charging device 80 may supply DC power supplied from the fast charger to the battery system 10. In a case where the connected charger is a slow charger, the charging device 80 may convert AC power supplied from the slow charger into DC power using an on board charge (OBC) (e.g., a high-frequency isolated converter, resonant converter, or buck-type converter, etc.) and then supply the DC power to the battery system 10.

The IVI system 40 (e.g., in-vehicle infotainment circuitry, vehicle control processor circuit, vehicle altitude-based charge control circuit, charging logic processor circuit, etc.) may receive position information of the vehicle 1 from the GPS device 60. If a current altitude of the vehicle 1 is higher than a predetermined threshold altitude (hereinafter, a first threshold altitude), the IVI system 40 may determine a target SOC of the battery system 10 as a predetermined SOC value (e.g., 60%, 70%, or 80%, etc.), and transmit the target SOC to the BMS 12. The target SOC refers to a SOC required by the driver when the battery system 10 is charged. The SOC is a ratio of a current charged capacity to a total capacity of the battery pack 11 (e.g., expressed as a percentage of full charge, etc.). The target charge rate will be referred to as a target SOC. In addition, if a difference between the current altitude of the vehicle 1 and an altitude of a destination (hereinafter, an altitude difference) is greater than or equal to the predetermined threshold altitude (hereinafter, a second threshold altitude) (e.g., 200 meters, 500 meters, or 1000 meters, etc.), the IVI system 40 may determine the target SOC of the battery system 10 as a predetermined SOC value (e.g., 70%, 75%, or 80%, etc.), and transmit the target SOC to the BMS 12. The IVI system 40 may obtain a destination from a navigation device (e.g., an integrated GPS navigation head unit, smartphone app, or cloud-connected service, etc.). The IVI system 40 may access an external server that provides a map to obtain altitude information of the destination (e.g., using digital elevation models or online geographic databases, etc.). The IVI system 40 may compare the vehicle altitude and the altitude difference with the first threshold altitude and the second threshold altitude, respectively, and limit the target SOC if at least one of the two comparison results is greater than or equal to a threshold altitude (e.g., to ensure regenerative braking capacity during extended downhill travel, etc.).

The IVI system 40 may receive position information of the vehicle 1 at the time when the vehicle 1 is turned on (e.g., via GPS signal acquisition or last known position cache, etc.), and may determine whether the current altitude of the vehicle 1 is higher than or equal to the first threshold altitude or whether the altitude difference of the vehicle 1 is higher than or equal to the second threshold altitude. In addition, the IVI system 40 may receive position information from the GPS device 60 while the vehicle 1 is moving (e.g., at fixed time intervals, distance-based triggers, or route checkpoints, etc.), and determine whether the current altitude of the vehicle 1 is higher than or equal to the first threshold altitude or whether the altitude difference of the vehicle 1 is higher than or equal to the second threshold altitude.

If the altitude of the vehicle 1 of the IVI system 40 is higher than or equal to the first threshold altitude or the altitude difference is higher than or equal to the second threshold altitude and the target SOC of the battery system 10 is limited, the IVI system 40 may notify, through a display device provided in the vehicle 1 (e.g., a center touchscreen, digital instrument cluster, or head-up display, etc.), that the maximum charging amount is limited due to the high altitude of the vehicle 1.

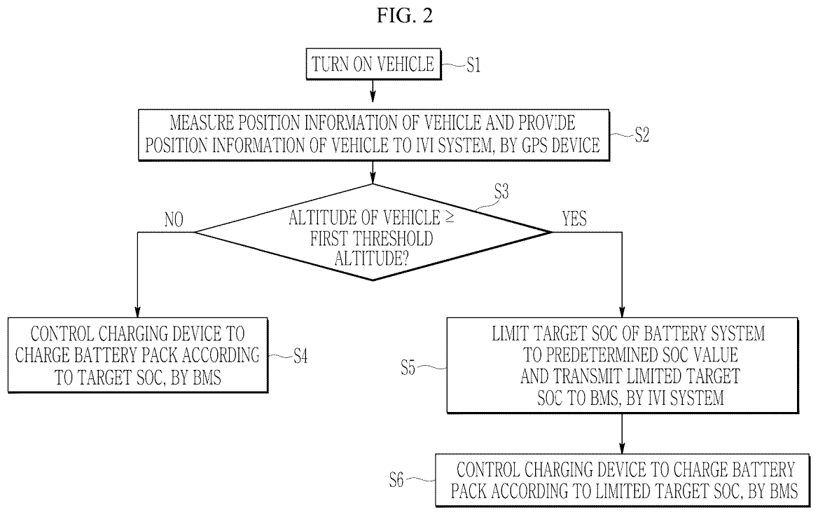

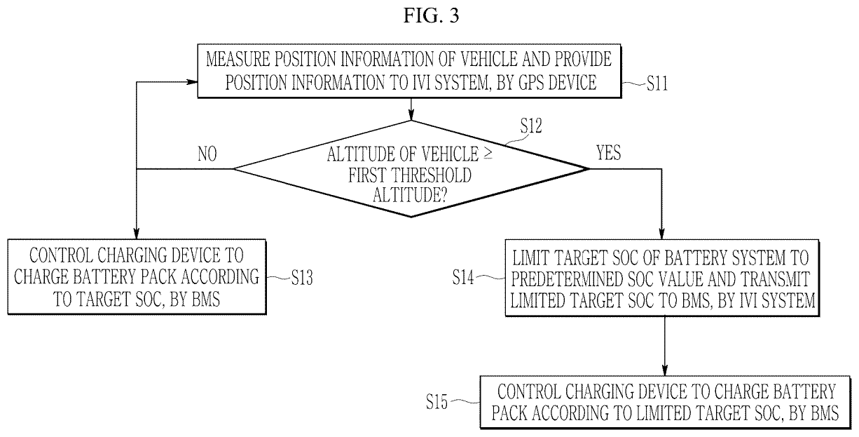

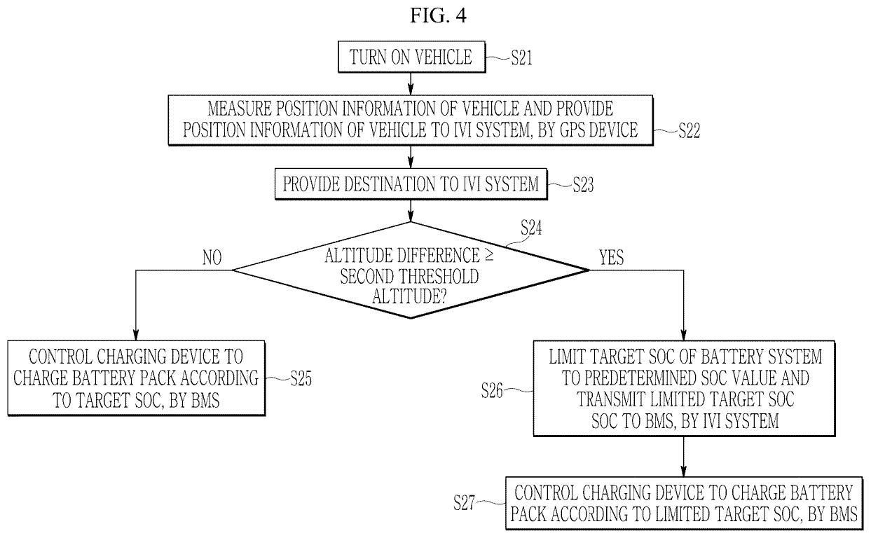

FIG. 2 is a flowchart illustrating a charging control method for a battery system according to an example.

First, the vehicle 1 is turned on by a driver's operation (S1) (e.g., pressing a start button or inserting a key, etc.).

As the vehicle 1 is turned on, the GPS device 60 may measure position information of the vehicle 1 (e.g., latitude, longitude, altitude, or speed, etc.), and provide the position information of the vehicle 1 to the IVI system 40 (S2).

The IVI system 40 may obtain an altitude of the vehicle 1 from the position information, and compare the altitude of the vehicle 1 with the first threshold altitude (S3) (e.g., using onboard elevation data or external map services, etc.).

If the altitude of the vehicle 1 is lower than the first threshold altitude as a result of the comparison in S3, the IVI system 40 does not limit the target SOC. That is, charging may be controlled according to a target SOC required by the driver (e.g., set via the IVI interface, mobile app, or default profile, etc.).

If charging is performed under the condition that the altitude of the vehicle 1 is lower than the first threshold altitude, the BMS 12 may control the charging device 80 to charge the battery pack 11 according to the target SOC (S4) (e.g., 90%, 95%, or a user-defined level, etc.). While estimating an SOC of the battery pack 11, the BMS 12 may transmit a charging stop signal to the charging device 80 when the estimated SOC reaches the target SOC (e.g., to prevent overcharging or ensure regenerative braking margin, etc.).

If the altitude of the vehicle 1 is higher than or equal to the first threshold altitude as a result of the comparison in S3, the IVI system 40 may limit the target SOC of the battery system 10 to a predetermined SOC value (e.g., 60%, 65%, 70%, or 75%, etc.), and transmit the limited target SOC to the BMS 12 (S5). For example, the limited target SOC may be 70%.

If charging is performed under the condition that the altitude of the vehicle 1 is higher than or equal to the first threshold altitude, the BMS 12 may control the charging device 80 to charge the battery pack 11 according to the limited target SOC (S6) (e.g., to preserve regenerative braking margin for anticipated downhill driving, etc.). While estimating an SOC of the battery pack 11, the BMS 12 may transmit a charging stop signal to the charging device 80 when the estimated SOC reaches the limited target SOC.

FIG. 3 is a flowchart illustrating a charging control method for a battery system according to an example.

While the vehicle 1 is moving, the GPS device 60 may measure position information of the vehicle 1, and provide the position information to the IVI system 40 (S11). The GPS device 60 may measure a position of the vehicle 1 at every predetermined measurement cycle (e.g., every 5 seconds, 100 meters of travel, or based on turn detection, etc.) to determine position information.

The IVI system 40 may obtain an altitude of the vehicle 1 from the position information, and compare the altitude of the vehicle 1 with the first threshold altitude (S12).

If the altitude of the vehicle 1 is lower than the first threshold altitude as a result of the comparison in S12, the IVI system 40 does not limit the target SOC. That is, charging may be controlled according to a target SOC required by the driver (e.g., as manually set via IVI interface or preconfigured profile, etc.). In a case where the altitude of the vehicle 1 is lower than the first threshold altitude as a result of the comparison in S12, the process of performing step S12 following step S11 may be repeated.

If charging is performed under the condition that the altitude of the vehicle 1 is lower than the first threshold altitude, the BMS 12 may control the charging device 80 to charge the battery pack 11 according to the target SOC (S13) (e.g., 90%, 95%, or a driver-selected level, etc.). While estimating an SOC of the battery pack 11 (e.g., using voltage curves, coulomb counting, or estimation algorithms, etc.), the BMS 12 may transmit a charging stop signal to the charging device 80 when the estimated SOC reaches the target SOC.

If the altitude of the vehicle 1 is higher than or equal to the first threshold altitude as a result of the comparison in S12, the IVI system 40 may limit the target SOC of the battery system 10 to a predetermined SOC value (e.g., 60%, 65%, 70%, or a value based on trip profile analysis, etc.), and transmit the limited target SOC to the BMS 12 (S14). For example, the limited target SOC may be 70%

If charging is performed under the condition that the altitude of the vehicle 1 is higher than or equal to the first threshold altitude, the BMS 12 may control the charging device 80 to charge the battery pack 11 according to the limited target SOC (S15) (e.g., 60%, 65%, or 70%, etc.). While estimating an SOC of the battery pack 11 (e.g., using sensor data, real-time current integration, or lookup tables, etc.), the BMS 12 may transmit a charging stop signal to the charging device 80 when the estimated SOC reaches the limited target SOC.

FIG. 4 is a flowchart illustrating a charging control method for a battery system according to an example.

First, the vehicle 1 is turned on by a driver's operation (S21) (e.g., key ignition, start button press, or remote start signal, etc.).

As the vehicle 1 is turned on, the GPS device 60 may measure position information of the vehicle 1, and provide the position information of the vehicle 1 to the IVI system 40 (S22).

Information on a destination input by the driver is provided to the IVI system 40 (S23) (e.g., via the navigation interface, voice input, or mobile app sync, etc.).

The IVI system 40 may obtain an altitude of the vehicle 1 from the position information, calculate an altitude difference between the altitude of the vehicle 1 and an altitude of the destination, and compare the altitude difference with the second threshold altitude (S24) (e.g., 200 m, 500 m, or another predefined elevation gap, etc.).

If the altitude difference is lower than the second threshold altitude as a result of the comparison in S24, the IVI system 40 does not limit the target SOC. That is, charging may be controlled according to the target SOC required by the driver (e.g., full charge for short trips, partial charge for extended storage, etc.).

If charging is performed under the condition that the altitude difference is lower than the second threshold altitude, the BMS 12 may control the charging device 80 to charge the battery pack 11 according to the target SOC (S25) (e.g., 90%, 95%, or a user-defined charging level, etc.). While estimating an SOC of the battery pack 11 (e.g., based on current integration, terminal voltage, or model-based prediction, etc.), the BMS 12 may transmit a charging stop signal to the charging device 80 when the estimated SOC reaches the target SOC.

If the altitude difference is higher than or equal to the second threshold altitude as a result of the comparison in S24, the IVI system 40 may limit the target SOC of the battery system 10 to a predetermined SOC value (e.g., 65%, 70%, or dynamically calculated based on trip profile, etc.), and transmit the limited target SOC to the BMS 12 (S26).

If charging is performed under the condition that the altitude difference is higher than or equal to the second threshold altitude, the BMS 12 may control the charging device 80 to charge the battery pack 11 according to the limited target SOC (S27) (e.g., set to 70%, 75%, or a value optimized for regenerative braking margin, etc.). While estimating an SOC of the battery pack 11 (e.g., using voltage-based estimation, coulomb counting, or a hybrid algorithm, etc.), the BMS 12 may transmit a charging stop signal to the charging device 80 when the estimated SOC reaches the limited target SOC.

FIG. 5 is a flowchart illustrating a charging control method for a battery system according to an example.

Information on a destination input by the driver is provided to the IVI system 40 (S30) (e.g., via a navigation interface, mobile app sync, or voice command, etc.).

While the vehicle 1 is moving, the GPS device 60 may measure position information of the vehicle 1, and provide the position information to the IVI system 40 (S31). The GPS device 60 may measure a position of the vehicle 1 at every predetermined measurement cycle (e.g., every 5 seconds, every 100 meters, or upon route deviation, etc.) to determine position information.

The IVI system 40 may obtain an altitude of the vehicle 1 from the position information, calculate an altitude difference between the altitude of the vehicle 1 and an altitude of the destination, and compare the altitude difference with the second threshold altitude (S32) (e.g., 200 meters, 500 meters, or other preset elevation thresholds, etc.).

If the altitude difference is lower than the second threshold altitude as a result of the comparison in S32, the IVI system 40 does not limit the target SOC. That is, charging may be controlled according to the target SOC required by the driver (e.g., full charge, energy-saving charge, or preset by user profile, etc.). In a case where the altitude difference is lower than the second threshold altitude as a result of the comparison in S32, the process of performing step S32 following step S31 may be repeated.

If charging is performed under the condition that the altitude difference is lower than the second threshold altitude, the BMS 12 may control the charging device 80 to charge the battery pack 11 according to the target SOC (S33) (e.g., 90%, 95%, or based on driver's preference, etc.). While estimating an SOC of the battery pack 11 (e.g., by tracking input current, terminal voltage, or using estimation algorithms, etc.), the BMS 12 may transmit a charging stop signal to the charging device 80 when the estimated SOC reaches the target SOC.

If the altitude difference is higher than or equal to the second threshold altitude as a result of the comparison in S32, the IVI system 40 may limit the target SOC of the battery system 10 to a predetermined SOC value (e.g., 60%, 65%, or an adaptive value based on driving history, etc.), and transmit the limited target SOC to the BMS 12 (S34).

If charging is performed under the condition that the altitude difference is higher than or equal to the second threshold altitude, the BMS 12 may control the charging device 80 to charge the battery pack 11 according to the limited target SOC (S35) (e.g., 60%, 65%, or dynamically selected based on route grade, etc.). While estimating an SOC of the battery pack 11 (e.g., using real-time voltage-current monitoring, Kalman filtering, or adaptive SOC tracking, etc.), the BMS 12 may transmit a charging stop signal to the charging device 80 when the estimated SOC reaches the limited target SOC.

During long-downhill driving, such as when a vehicle is descending from a high-altitude ground (e.g., mountainous roads, elevated highways, or steep terrain, etc.), friction braking may occur frequently by applying the brake. Then, heat may be generated in a brake disc, a brake caliper, etc., and the brake disc and the brake caliper may be damaged (e.g., due to thermal warping, fluid boil, or pad glazing, etc.). The higher the current battery charging rate, the lower the regenerative braking utilization rate. When the battery is in a fully charged state, it may be difficult to practically utilize regenerative braking because regenerative power generated by the regenerative braking cannot be used as charging power. According to examples of the present disclosure, when the vehicle is located at a high-altitude place, long-downhill driving is expected, and the target SOC of the battery system is limited (e.g., capped at 70%, 75%, or another configurable level, etc.) to increase the regenerative braking rate. Then, the friction braking rate is reduced during the long-downhill driving, so that the heat generated in the brake disk and the caliper can be reduced, and damage can be prevented (e.g., improving brake longevity, maintaining braking performance, and enhancing safety, etc.).

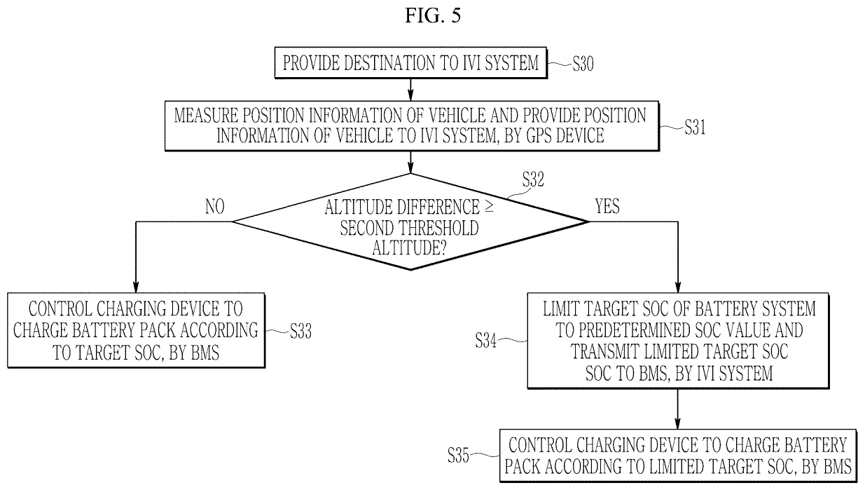

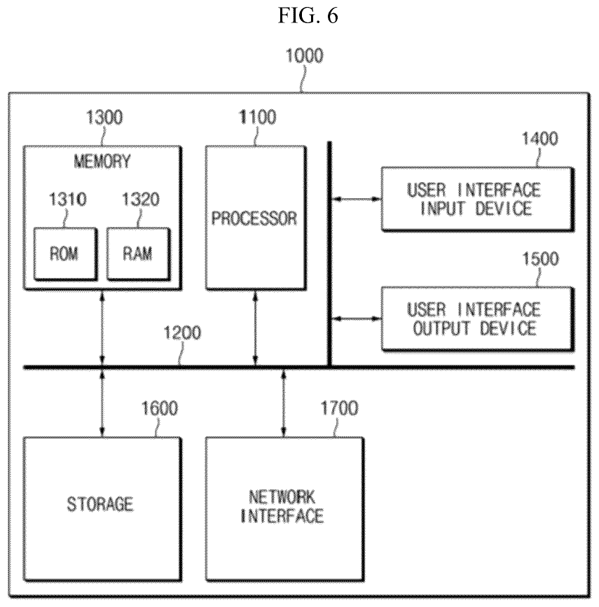

FIG. 6 shows an example computing system (e.g., a computing device of a vehicle or any other apparatus). One or more controllers, processors, etc. described herein, such as one or more components of the vehicle, and any other components and devices disclosed herein, may be implemented by or in the computing system as shown in FIG. 6.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

An example of the present disclosure provides a vehicle including: a motor providing power to the vehicle; an inverter electrically connected to the motor, and supplying power to the motor or receiving power from the motor; a battery system supplying power to the inverter or receiving charging power from the inverter; a GPS device measuring an altitude of the vehicle; and an IVI system comparing the measured altitude of the vehicle with a predetermined first threshold altitude, and limiting a target SOC (State of Charge) for the battery system to a predetermined first SOC value and setting the limited target SOC if the altitude of the vehicle is higher than or equal to the first threshold altitude as a result of the comparison.

The vehicle may further include a starting device driving or stopping the motor. When receiving a signal from the starting device to instruct the vehicle to be turned on, the IVI system may compare the altitude of the vehicle measured by the GPS device with the first threshold altitude.

The IVI system may transmit the limited target SOC to the battery system, and the battery system may perform charging according to the limited target SOC.

The vehicle may further include a charging device electrically connected to the battery system, and the battery system may include: a battery pack including a plurality of cells; and a battery management system (BMS) controlling charging of the battery pack. During the charging, the BMS may estimate an SOC of the battery pack, and stop the charging device if the SOC reaches the limited target SOC.

The IVI system may compare an altitude difference between the measured altitude of the vehicle and an altitude of a destination of the vehicle with a predetermined second threshold altitude, and limit the target SOC for the battery system to a predetermined second SOC value and set the limited target SOC if the altitude of the vehicle is higher than or equal to the second threshold altitude as a result of the comparison.

An example of the present disclosure provides a charging control method for a battery system, the charging control method including: measuring position information of a vehicle, by a GPS device of the vehicle; obtaining an altitude of the vehicle from the position information, and comparing the altitude of the vehicle with a predetermined first threshold altitude, by an IVI system; and if the altitude of the vehicle is higher than or equal to the first threshold altitude as a result of the comparison, limiting a target SOC for the battery system to a predetermined first SOC value and setting the limited target SOC, by the IVI system.

The charging control method may further include: transmitting the limited target SOC to the battery system, by the IVI system; and controlling the charging device according to the limited target SOC, by the battery system.

The charging control method may further include: turning on the vehicle, and the measuring of the position information may be performed as the vehicle is turned on.

The measuring of the position information may be performed at every predetermined measurement cycle while the vehicle is moving.

The charging control method may further include: comparing an altitude difference between the measured altitude of the vehicle and an altitude of a destination of the vehicle with a predetermined second threshold altitude; and if the altitude of the vehicle is higher than or equal to the second threshold altitude as a result of the comparison between the altitude difference and the second threshold altitude, limiting the target SOC for the battery system to a predetermined second SOC value and setting the limited target SOC.

The charging control method may further include: when the limited target SOC is set, notifying that the limited target SOC has been set through a display device of the vehicle, by the IVI system.

By controlling the SOC of the battery of the vehicle prior to long-downhill driving according to the present disclosure, the vehicle can overcome the constraints depending on the state of charge of the battery in determining the regenerative braking amount during the long-downhill driving. As the regenerative braking utilization rate increases during the long-downhill driving, the frequency of friction braking decreases, making it possible to reduce heat generated in a brake disc, a caliper, etc., and prevent damage to the brake disc, the caliper, etc. In addition, it is possible to increase the amount in which the battery system of the vehicle is charged by the increased regenerative braking.

Although the examples of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. A vehicle comprising:
a motor configured to provide power to the vehicle;
an inverter electrically connected to the motor, and configured to supply power to the motor or receive power from the motor;
a battery system configured to supply power to the inverter or receive charging power from the inverter;
a Global Positioning System (GPS) device configured to measure an altitude of the vehicle; and
in-vehicle infotainment (IVI) circuitry configured to:
compare the measured altitude of the vehicle with a predetermined first threshold altitude, and
limit, based on the measured altitude of the vehicle being higher than or equal to the predetermined first threshold altitude, a target state of charge (SOC) for the battery system to a predetermined first SOC value.

2. The vehicle of claim 1, further comprising:
an ignition interface configured to cause driving or stopping the motor,
wherein, based on receiving a signal from the ignition interface to instruct the vehicle to be turned on, the IVI circuitry is configured to compare the altitude of the vehicle with the predetermined first threshold altitude.

3. The vehicle of claim 1, wherein
the IVI circuitry is configured to transmit the limited target SOC to the battery system, and
the battery system is configured to perform charging based on the limited target SOC.

4. The vehicle of claim 3, further comprising:
a charging interface electrically connected to the battery system,
wherein the battery system comprises:
a battery pack including a plurality of cells; and
a battery management circuit configured to control charging of the battery pack, and
during the charging, the battery management circuit is configured to estimate an SOC of the battery pack, and cause the charging interface to stop the charging of the battery pack based on the SOC reaching the limited target SOC.

5. The vehicle of claim 1, wherein
the IVI circuitry is configured to:
compare an altitude difference with a predetermined second threshold altitude, wherein the altitude difference is a difference between the measured altitude of the vehicle and an altitude of a destination of the vehicle, and
limit the target SOC for the battery system to a predetermined second SOC value based on the altitude difference being higher than or equal to the predetermined second threshold altitude.

6. The vehicle of claim 1, wherein the target SOC is limited such that at least a portion of regenerative power generated during downhill driving of the vehicle is provided to charge a battery of the battery system instead of using friction braking for reducing a speed of the vehicle.

7. The vehicle of claim 1, further comprising:
a regenerative braking control circuit configured to allocate, based on the limited target SOC, braking torque between friction braking of the vehicle and regenerative braking of the vehicle.

8. A method performed by a vehicle, the method comprising:
obtaining, via a Global Positioning System (GPS) device of the vehicle, position information of the vehicle;
determining, based on the position information, an altitude of the vehicle;
comparing, via in-vehicle infotainment (IVI) circuitry of the vehicle, the altitude of the vehicle with a predetermined first threshold altitude; and
based on the altitude of the vehicle being higher than or equal to the predetermined first threshold altitude, limiting, via the IVI circuitry of the vehicle, a target SOC for a battery system of the vehicle to a predetermined first SOC value.

9. The method of claim 8, further comprising:
transmitting, via the IVI circuitry of the vehicle, the limited target SOC to the battery system; and
controlling, via a charging interface of the battery system and based on the limited target SOC, charging of the battery system.

10. The method of claim 8, wherein the obtaining of the position information comprises obtaining, based on turning on the vehicle, the position information.

11. The method of claim 8, wherein the obtaining of the position information comprises obtaining the position information at every predetermined measurement cycle while the vehicle is moving.

12. The method of claim 8, further comprising:
comparing an altitude difference with a predetermined second threshold altitude, wherein the altitude difference is a difference between the determined altitude of the vehicle and an altitude of a destination of the vehicle; and
based on the altitude difference being higher than or equal to the predetermined second threshold altitude, limiting the target SOC for the battery system to a predetermined second SOC value.

13. The method of claim 8, further comprising:
displaying, by the IVI circuitry and via a display device of the vehicle, the limited target SOC.

14. The method of claim 8, wherein the limiting of the target SOC is performed such that at least a portion of regenerative power generated during downhill driving of the vehicle is provided to charge a battery of the battery system instead of using friction braking for reducing a speed of the vehicle.

15. The method of claim 8, further comprising:
allocating, based on the limited target SOC, braking torque between friction braking of the vehicle and regenerative braking of the vehicle.

16. A vehicle comprising:
a motor configured to provide driving power for the vehicle;
an inverter configured to supply power to the motor or receive power from the motor;
a battery system configured to supply power to the inverter or receive charging power from the inverter;
a positioning circuit configured to determine an altitude of the vehicle; and
onboard information circuitry configured to:
determine, based on the altitude of the vehicle satisfying a predetermined threshold, an estimated power generation by regenerative braking of the vehicle via a downhill driving,
based on the determined estimated power generation, set a limit to a target state of charge (SOC) of the battery system such that the target SOC does not exceed a predetermined SOC value lower than a full charge, and
provide information indicating the limited target SOC to the battery system to reserve regenerative braking capacity of the battery system,
wherein the battery system is further configured to limit charging of a battery pack based on the limited target SOC, such that at least a portion of regenerative power generated during downhill driving is provided to the battery pack of the battery system.

17. The vehicle of claim 16, wherein the motor is configured to generate electric power by applying regenerative braking of the vehicle during downhill driving, and wherein the electric power generated by the motor is provided to charge the battery pack an SOC level that is above the limited target SOC.

18. The vehicle of claim 16, further comprising:
a regenerative braking control circuit configured to allocate, based on the limited target SOC, braking torque between friction braking of the vehicle and regenerative braking of the vehicle.

19. The vehicle of claim 16, wherein the threshold comprises:
a first threshold altitude for determining whether a current altitude of the vehicle is greater than or equal to the first threshold altitude, and
a second threshold altitude for determining whether a difference between the current altitude of the vehicle and an altitude of a destination of the vehicle is greater than or equal to the second threshold altitude.

20. The vehicle of claim 16, wherein the positioning circuit is further configured to determine, based on navigation data of the vehicle, an altitude of a destination of the vehicle, and wherein the onboard information circuitry is further configured to determine an altitude difference between the altitude of the vehicle and the altitude of the destination and compare the altitude difference with a threshold difference to determine the estimated power generation by regenerative braking.
